(19) United States
(12) Patent Application Publication
(10) Pub. No.: US 2007/0003838 A1
(43) Pub. Date: Jan. 4, 2007

(54) Energy device

(76) Inventors: Yoshiaki Kumashiro, Mito (JP); Juichi Arai, Shirosato (JP); Mituru Kobayashi, Hitachiota (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/206,186

(22) Filed: Aug. 18, 2005

(30) Foreign Application Priority Data
Sep. 22, 2004 (JP) 2004-274325

(51) Int. Cl. H01M 10/40; H01M 4/58; H01G 9/035

(52) U.S. Cl. 429/324; 429/326; 429/329; 429/330; 429/231.8; 361/504; 361/505

(57) ABSTRACT

An energy device with high input/output characteristics and superior characteristics particularly at low temperature. The energy device stores and releases electric energy by means of a faradaic reaction mechanism based mainly on the alteration of the oxidation state of an active material whereby charges move into the active material, and a non-faradaic reaction based mainly on the physical adsorption and separation of ions on the surface of an active material for storing or releasing charges. The output characteristics at low temperature are improved by employing at least two kinds of faradaic reaction mechanism, namely, one with low reaction rate and the other with high reaction rate, which is mainly based on the alteration of the oxide state of an active material for the transfer of charges into the active material via an electrode interface.

### BACKGROUND OF THE INVENTION

1. Field of the Invention

The present invention relates to an energy device for storing and releasing electric energy.

2. Background Art

In recent years, power supplies for electric vehicles, hybrid vehicles, or electric tools are required to have higher input and output capabilities. The are also required to be adapted for quicker charge and discharge operations and to have greater capacities. Particularly, power supplies are called for that have smaller temperature dependency and that can maintain their input and output characteristics at low temperatures, such as at −20° C. or −30° C.

Such demands have so far been dealt with by performance improvements on the secondary batteries with faradaic reaction mechanism, such as lithium secondary batteries, nickel metal hydride batteries, nickel cadmium batteries, and lead-acid batteries. Another response has been to employ, in combination with any of the aforementioned secondary batteries, an electric double layer capacitor, which is a power supply with a non-faradaic reaction mechanism that is capable of instantaneous input/output performance with good output characteristics and performance at low temperature environment. Patent Document 1 discloses a lithium secondary battery in which, with a view to achieving a higher energy density, higher output density, and improvements on low temperature characteristics, activated charcoal, which is used as a material for the electric double layer capacitor, is mixed in the positive electrode of the lithium secondary battery.

Patent Document 1: JP Patent Publication (Kokai) No. 2002-260634 A

### SUMMARY OF THE INVENTION

The conventional secondary batteries, however, have poor charge/discharge characteristics at large currents, and particularly the input/output characteristics drop significantly at low temperature environments. Furthermore, the electric double layer capacitor has a low energy density problem.

It is therefore an object of the invention to provide a novel energy device that can overcome the disadvantages of the prior art and that has excellent input/output characteristics at low temperatures.

In order to achieve the object, the invention provides an energy device comprising a positive electrode and a negative electrode that store electricity by a faradaic reaction and a non-faradaic reaction, and an electrolytic solution containing a solvent represented by Formula 1 in which mobile ion is stored.

The novel energy device has excellent input/output characteristics at low temperature.

### BRIEF DESCRIPTION OF THE DRAWINGS

FIG. 1(a) shows a cross section of a coin type energy device according to an embodiment of the invention. FIG. 1(b) shows a cross section of a coin type energy device according to another embodiment of the invention.

FIG. 2 shows a cross section of a coin type energy device in which a fast positive-electrode faradic reaction layer or a positive-electrode non-faradic reaction layer is formed only in the positive-electrode.

FIG. 3 shows a cross section of a coin type energy device in which a fast positive-electrode faradic reaction layer or a positive-electrode non-faradic reaction layer is formed only in the negative-electrode.

FIG. 4 shows a cross section of a coin type lithium secondary battery.

FIG. 5 shows a graph depicting output characteristics.

FIG. 6 shows discharge curves of Example 1 and Comparative Example 1.

FIG. 7 shows a cross section of a coin type energy device of Example 3.

FIG. 8 shows discharge curves of Examples 3 and 4 and Comparative Example 1.

FIG. 9 shows an energy storage device module.

FIG. 10 shows a hybrid electric vehicle.

### DESCRIPTION OF PREFERRED EMBODIMENTS OF THE INVENTION

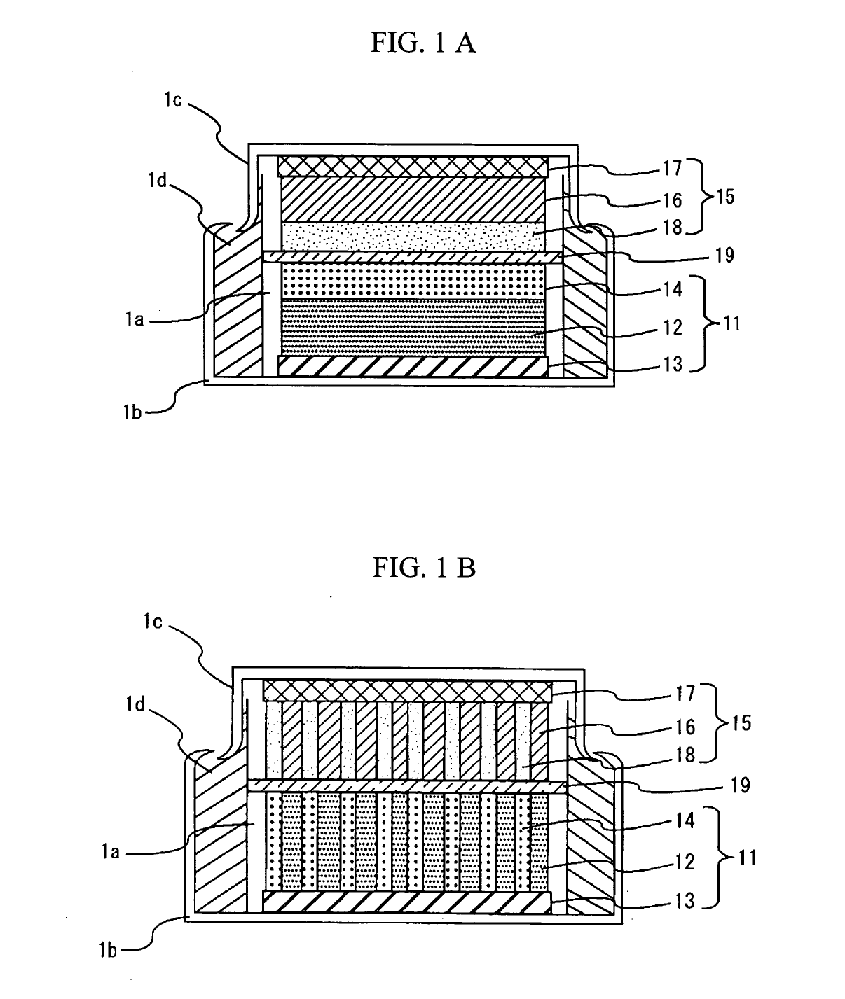

An embodiment of the invention is described with reference to FIG. 1. FIG. 1(a) shows a cross section of a coin type energy device according to the embodiment of the invention.

A positive electrode 11 is prepared by coating a positive-electrode collector with a positive-electrode faradic reaction layer 12, which is a layer in which a faraday reaction occurs, and a layer (to be hereafter referred to as “a fast positive-electrode faradic reaction layer”) with a higher reaction rate than that of the positive-electrode faradic reaction layer 12 or a layer (to be hereafter referred to as “a positive-electrode non-faradic reaction layer”) 14 for producing a non-faraday reaction.

A negative electrode 15 is prepared by coating a negative electrode collector 17 with a negative electrode faradic reaction layer 16, which is a layer in which a faraday reaction occurs, and a layer (to be hereafter referred to as “a fast negative-electrode faradic reaction layer) with a higher reaction rate than that of the negative-electrode faradic reaction layer 16, or a layer (to be hereafter referred to as a negative-electrode non-faradaic layer) 18 for producing a non-faraday reaction.

The term “faradaic reaction” herein refers to a reaction in which the oxidization state of an active material is altered and electric charges pass through an electric double layer and move into the active material via the electrode interface. This is a mechanism similar to the reaction in primary or secondary batteries. On the other hand, the term “non-faradaic reaction” herein refers to a reaction in which the movement of electric charges through the electrode interface does not occur, but instead the electric charges are stored or released through the physical adsorption or separation of ions on the electrode surfaces. This is a mechanism similar to the reaction that takes place in the electric double layer capacitor.

Similarly, the term “layer in which a faradaic reaction takes place” herein refers to the layer in which the oxidization state of an active material is altered and electric charges pass through the electric double layer and move into the active material via the electrode interface. On the other hand, the term “layer in which mostly non-faradaic reaction takes place” refers to a layer in which the movement of electric charges through the electrode interface does not occur, but instead the electric charges are stored or released through the physical adsorption or separation of ions on the electrode surfaces.

There is also a reaction in which electric charges are stored at the electrode interface, as in the case of non-faradaic reaction and at the same time a faradaic reaction occurs in which electrons are exchanged with the active substance. This is a mechanism similar to the reaction in an energy device referred to as a redox capacitor. Although this reaction is accompanied by a faradaic reaction, its reaction rate is higher than that of the faradaic reaction in secondary batteries, for example. Thus, the individual faradaic reactions in the redox capacitors and in the secondary batteries will be hereafter referred to as faradaic reactions with different reaction rates. Specifically, the faradaic reaction in the redox capacitor will be referred to as a faradaic reaction with higher reaction rate, and the faradaic reaction in the secondary battery will be referred to as a faradaic reaction with lower reaction rate.

The terms “faradaic” and “non-faradaic” have been typified to refer to the type of battery and the mode of energy storage. Because the layer in which the faradaic reaction with high reaction rate or the non-faradaic reaction takes place can be disposed closer to the opposite electrode in a more concentrated manner, an effect similar to that of a capacitor can be more strongly exhibited.

Preferably, the area of the portion of the layer in which a non-faradaic reaction takes place that is exposed to the opposite electrode is 30 to 100%.

In the conventional lithium secondary battery, when the activated charcoal that is used as a material for the electric double layer capacitor is mixed in the positive-electrode of the lithium secondary battery, it is difficult to increase the amount of activated charcoal that is mixed. In addition, the capacitor has limited capacity. Therefore, sufficient improvements have not been achieved.

In contrast, the energy device that is configured in accordance with the present embodiment has superior output characteristics, particularly at low temperatures.

The energy device of the embodiment comprises the positive-electrode 11 and the negative-electrode 15 that are electrically insulated with an insulating layer 19 that passes only mobile ions interposed therebetween. After the electrodes and the insulating layer are placed inside a casing, an electrolytic solution is injected. A positive-electrode can 1b and a negative-electrode can 1c, which are electrically insulated, are sealed with a gasket 1d. The insulating layer and the electrodes are caused to carry a sufficient amount of electrolytic solution 1a so that the electric insulation between the positive-electrode 11 and the negative-electrode 15 can be ensured and ions can be exchanged between the positive-electrode and negative-electrode.

In the energy device according to the present embodiment, the layers are stacked in order of the positive-electrode faradic reaction layer 12, the fast positive-electrode faradic reaction layer or positive-electrode non-faradic reaction layer 14, the insulating layer 19, the fast negative-electrode faradic reaction layer or negative-electrode non-faradic reaction layer 18, and the negative-electrode faradic reaction layer 16.

It is also possible to manufacture an energy device with a shape other than that of a coin. When a cylindrical energy device is to be manufactured, the layered structure is wound to obtain a group of electrodes. Specifically, the positive-electrode, which is a laminate of the positive-electrode collector, the positive-electrode, and the layer in which the faradaic reaction with higher reaction rate or the non-faradaic reaction takes place, and the negative-electrode, which is a laminate of the negative-electrode collector, the negative-electrode, and the layer in which the faradic reaction with higher reaction rate or the non-faradaic reaction takes place are wound, with the layers in which the faradaic reaction with higher reaction rate or the non-faradaic reaction takes place being disposed opposite to one another and with the insulating layer interposed therebetween. Alternatively, if the electrodes are wound about two axes, a oval group of electrodes can be obtained. When a square-shaped energy device is to be obtained, the positive-electrode and negative-electrode are cut into short strips which are then stacked with the positive-electrode and negative-electrode disposed alternately, with an insulating layer being interposed between the individual electrodes, thereby preparing a square group of electrodes. It goes without saying that the shape of the electrode group according to the invention is not limited to any of the aforementioned shapes, namely, coin type, wound, or square, and the invention can be realized with any desired shape.

FIG. 1(b) shows another embodiment of the invention. In this figure, the reference numerals are identical to those employed in FIG. 1(a). In the present embodiment, the positive-electrode 11 and the negative-electrode 15 are disposed in the longitudinal direction of the coin type battery with the insulating layer interposed therebetween. The positive-electrode faradic reaction layer 12 and the fast positive-electrode faradic reaction layer or positive-electrode non-faradic reaction layer 14 are disposed in the lateral direction, namely, they are stacked in the direction in which the positive-electrode collector extends. The same relationship applies to the negative-electrode faradic reaction layer 16, and the fast negative-electrode faradic reaction layer or negative-electrode non-faradic reaction layer 18.

In the following, a method will be described for preparing the positive-electrode 11 and the negative-electrode 15 using the positive-electrode faradic reaction layer 12 and the negative-electrode faradic reaction layer 16 in which lithium ions can be inserted or separated as an active material causing a faradaic reaction.

The active material in the positive-electrode faradic reaction layer 12 consists of an oxide containing lithium. Examples of such an oxide include oxides with a layered structure, such as LiCoO₂, LiNiO₂, LiMn_{1/3}Ni_{1/3}Co_{1/3}O₂, or LiMn_{0.4}Ni_{0.4}Co_{0.2}O₂, and oxides of Mn with a spinel crystal structure, such as LiMn₂O₄ or Li₁₊ₓMn₂₋ₓO₄, and Mn that has been partially substituted by another element, such as Co or Cr.

Because a positive-electrode active material generally has high resistance, the electric conductivity of the positive-electrode active material is compensated by mixing carbon powder as a conductant agent. Because the positive-electrode active material and the conductant agent are both in powder form, they are mixed with a binder when they are applied to the positive-electrode collector 13 and formed.

Examples of the conductant agent that can be used include natural graphite, artificial graphite, coke, carbon black, and amorphous carbon. The positive-electrode collector needs only to be made of a material that is hard to be dissolved in the electrolytic solution, such as aluminum foil, for example. The positive-electrode faradic reaction layer 12 is made by the doctor blade method, whereby a positive-electrode slurry consisting of a mixture of the positive-electrode active material, conductant agent, binder, and an organic solvent is applied to the positive-electrode collector 13 using a blade. The organic solvent is then evaporated by heating.

Further, in the energy device of the present embodiment, the layer in which the faradaic reaction with high reaction rate or the non-faradaic reaction takes place is applied to the thus prepared positive-electrode faradic reaction layer 12.

The layer in which the non-faradaic reaction takes place can be made of a substance with a relatively large specific surface area in which no redox reaction takes place in a wide potential range, such as carbon materials including activated charcoal, carbon black, and carbon nanotubes. Preferably, activated charcoal is used from the viewpoint of specific surface area and material cost. A more preferable example is activated charcoal with a particle size of 1 to 100 μm and a specific surface area of 1000 to 3000 m²/g, that has fine openings referred to as micropores with a diameter of 0.002 μm or smaller, mesopores with a diameter of 0.002 to 0.05 μm, and macropores with a diameter of 0.05 μm or greater.

The layer in which the faradaic reaction with high reaction rate takes place may be formed of conductive polymer material, such as polyaniline, polythiophene, polypyrrole, polyacene, or polyacethylene, or a fine powder of graphite.

A slurry consisting of a mixture of these materials and a binder is applied to the top of the positive-electrode faradic reaction layer 12. Then, the fast positive-electrode faradaic reaction layer or positive-electrode non-faradic reaction layer is bonded to the positive-electrode faradic reaction layer 12. The thus prepared positive-electrode mixture and the fast faradic reaction layer or positive-electrode non-faradic reaction layer are heated, whereby the organic solvent is evaporated. This is followed by the press-forming of the positive-electrode using a roll press, whereby the positive-electrode collector 13, the positive-electrode faradic reaction layer 12 and the fast positive-electrode faradic reaction layer or positive-electrode non-faradic reaction layer 14 can be closely attached to one another, thereby obtaining a positive-electrode.

The binder used herein is a fluorine-containing resin, such as polytetrafluoroethylene, polyvinylidene fluoride, or fluororubber, a thermoplastic resin, such as polypropylene or polyethylene, or a thermosetting resin, such as polyvinyl alcohol. For the negative-electrode active material, graphite or amorphous carbon, which are capable of electrochemically storing and releasing lithium, may be used. Aside from carbon materials, oxide negative-electrode, such as SnO₂, or an alloy material containing Li, Si or Sn may be used. It is also possible to use a compound material consisting of an oxide negative-electrode or an alloy material and a carbon material.

Because negative-electrode active materials are generally in powder form, they are mixed with a binder, and the mixture is then applied to the negative-electrode collector 17 and then formed. The negative-electrode collector needs only to be of a material that is hard to be made into an alloy with lithium. An example is copper foil. A negative-electrode slurry consisting of a mixture of a negative-electrode active material, a binder, and an organic solvent is applied to the negative-electrode collector 17 by the doctor blade method, for example, and then the organic solvent is evaporated. As in the case of the positive-electrode, it is also possible to further apply a fast negative-electrode faradic reaction layer or negative-electrode non-faradic reaction layer.

The layer in which the non-faradaic reaction takes place may be formed of a substance with a large specific surface area that does not produce a redox reaction in a large potential range. Examples are carbon material such as activated charcoal, carbon black, and carbon nanotubes, and fine powder of graphite, which is capable of storing and releasing lithium ions. The layer in which faradaic reaction with high reaction rate takes place can be formed of a conductive polymer material, such as polyaniline, polythiophene, polypyrrole, polyacene, or polyacethylene, or a fine powder of graphite. These materials are mixed with a binder to prepare a slurry which is applied to the top of the negative-electrode collector 17, thereby bonding the fast negative-electrode faraday reaction or negative-electrode non-faradic reaction layer to the negative-electrode collector 17.

The thus coated negative-electrode is press-formed using a roll press into a negative-electrode 15.

The insulating layer 19, which is used to electrically insulate the positive-electrode 11 and the negative-electrode 15, is a layer that passes only mobile ions and which consists of a polymeric porous film of, e.g., polyethylene, polypropylene, or polytetrafluoroethylene. The electrolytic solution 1a may consist of an organic solvent, such as ethylene carbonate (EC), propylene carbonate (PC), dimethyl carbonate (DMC), diethyl carbonate (DEC), or methyl ethyl carbonate (MEC), in which approximately 0.5M to 2M in volume concentration of a lithium-salt electrolyte, such as lithium hexafluorophosphate (LiPF₆) or lithium tetrafluoroborate (LiBF₄), is contained. A preferable example of electrolytic solution is a solvent consisting of a mixture of the solvent represented by Formula 1 and at least one solvent selected from the group consisting of propylene carbonate, butylene carbonate, dimethyl carbonate, ethyl methyl carbonate, diethyl carbonate, methyl acetate, ethyl acetate, propyl acetate, methyl formate, ethyl formate, propyl formate, γ-butyrolactone, α-acetyl-γ-butyrolactone, α-methoxy-γ-butyrolactone, dioxolan, sulfolane, or ethylene sulfite. 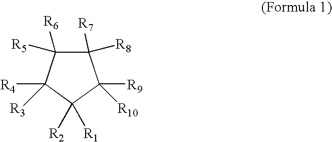
(R₁ to R₁₀ are hydrogen, fluorine, or a methyl or methoxy group and may all be the same or different from one another.)

Preferably, the solvent represented by Formula 1 is 1,1,2,2,3,3,4-heptafluoro-cyclopentane. To such a solvent may be added 0.5M to 2M in volume concentration of lithium salt electrolyte such as LiPF₆, LiBF₄, LiSO₂CF₃, LiN[SO₂CF₃]₂, LiN[SO₂CF₂CF₃]₂, LiB[OCOCF₃]₄, or LiB[OCOCF₂CF₃]₄. In addition to the Li salts or Li compounds, a salt including a quaternary onium cation represented by Chemical Formula 1 shown below, such as tetraalkylphosphonium-tetrafluoroborate, tetraalkylammonium-tetrafluoroborate, or triethylmethyl, may be added. 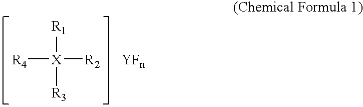
(R₁, R₂, R₃, and R₄ are H or alkyl groups with carbon number of 1 to 3, which may all be the same or different from one another; X is N or P; Y is B, P, or As; and n is an integer of 4 or 6.)

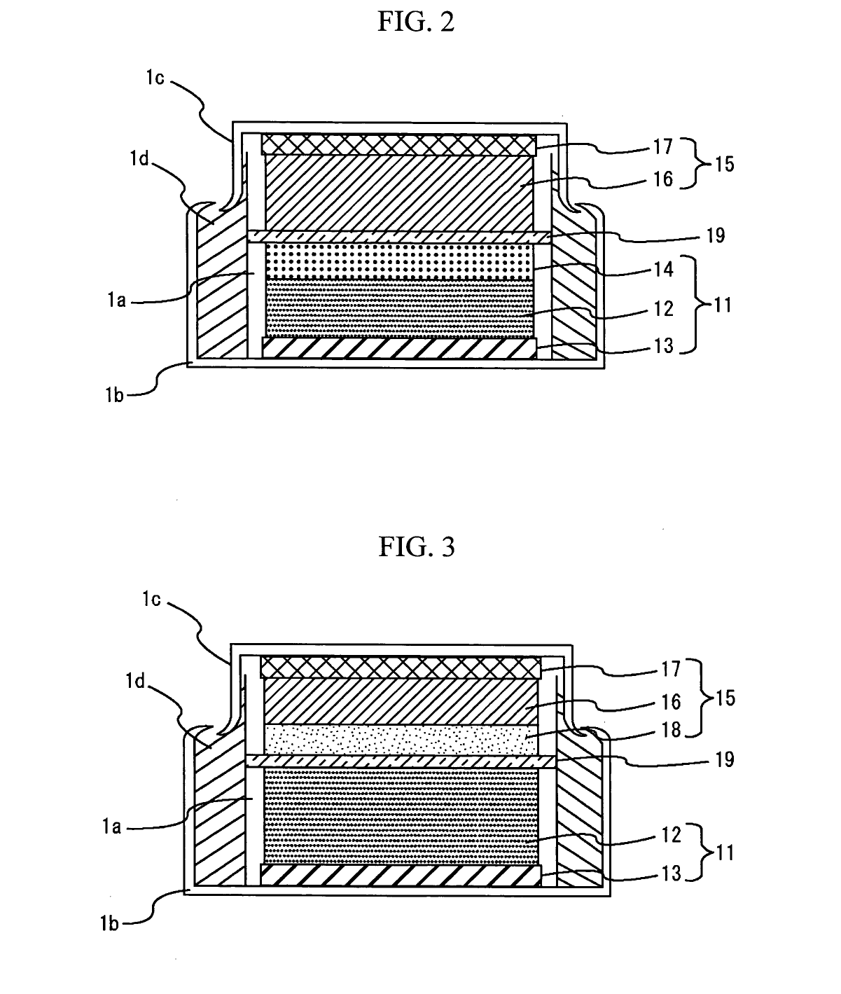

Although in the above description referring to FIG. 1 the positive-electrode 11 and the negative-electrode 15 are both provided with the layer in which fast faradaic reaction or non-faradaic reaction takes place, it is also possible to form the fast positive-electrode faradic reaction layer or positive-electrode non-faradic reaction layer 14 only for the positive-electrode 11, as shown in FIG. 2. The configuration of the positive-electrode and negative-electrode may be appropriately selected to be longitudinal direction/longitudinal direction, lateral direction/lateral direction, longitudinal direction/lateral direction, or lateral direction/longitudinal direction.

Further optionally, the fast negative-electrode faradic reaction layer or negative-electrode non-faradic reaction layer 18 may be formed only for the negative-electrode 15, as shown in FIG. 3.

Furthermore, the energy device may be produced by substituting the insulating layer 19 shown in FIGS. 1, 1(b), 2, and 3 with a gel electrolyte.

The gel electrolyte may be prepared by causing a polymer, such as polyethylene oxide (PEO), polymethacrylate (PMMA), polyacrylonitrile (PAN), polyvinylidene fluoride (PVdF), or polyvinylidene fluoride-hexafluoropropylene copolymer (PVdF-HFP), to be swollen with an electrolytic solution.

An energy device module can be produced by connecting a plurality of the above-described energy devices in the following manner.

A plurality of the energy devices are connected in series depending on the voltage to be obtained. Means for detecting the voltage of each device, and means for controlling the charge and discharge currents that flow in each energy device are provided. There is also provided means for giving instructions to the foregoing two means. The individual means communicate with one another via electric signal.

When charging, a particular energy device is charged by causing current to flow to the energy device if the voltage of the device detected by the aforementioned voltage detecting means is lower than a predetermined charge voltage. Energy devices whose voltage has reached the predetermined charge voltage are prevented from being overcharged by terminating the flow of charge current in response to an electric signal from the instruction-giving means.

When discharging, the voltage of the individual energy devices is similarly detected by the voltage detecting means, and the flow of charge current to a particular energy device is terminated if the energy device has reached a predetermined discharge voltage. The accuracy of detection of voltage is preferably on the order of 0.1V or smaller in terms of voltage resolution, and more preferably 0.02V or smaller. By thus detecting the voltages of the individual energy devices accurately and controlling their operation so as to prevent them from either overcharged or overdischarged, an energy device module can be realized.

In the following, examples of the energy device of the invention are described in detail. It is noted, however, that the invention is not limited to any of those examples.

### EXAMPLE 1

A coin type energy device with the configuration of FIG. 2 was made. The positive-electrode faradic reaction layer 12 was prepared as follows. The positive electrode active material was formed of Li_{1.05}Mn_{1.95}O₄ with a mean particle size of 10 μm. The conductant agent was formed of a mixture with a weight ratio of 4:1 of graphite carbon with a mean particle size of 3 μm and specific surface area of 13 m²/g, and carbon black with a mean particle size of 0.04 μm and specific surface area of 40 m²/g. Using a binder made by dissolving 8 wt. % of polyvinylidene fluoride in N-methylpyrrolidone in advance, the positive electrode active material, conductant agent, and polyvinylidene fluoride were mixed to the weight ratio of 85:10:5, and the mixture was sufficiently kneaded, thereby obtaining a positive-electrode slurry. The positive-electrode slurry was applied to one side of positive-electrode collector 13 composed of an aluminum foil with a thickness of 20 μm and dried. The positive-electrode collector was then pressed using a roll press, thereby preparing an electrode. Further, activated charcoal with specific surface area of 2000 μm²/g and carbon black with a mean particle size of 0.04 μm and specific surface area of 40 m²/g were mixed to a weight ratio of 8:1. Using a binding agent formed by dissolving 8 wt. % of polyvinylidene fluoride in N-methylpyrrolidone in advance, the activated charcoal, carbon black, and polyvinylidene fluoride were mixed to a weight ratio of 80:10:10, and the mixture was then sufficiently kneaded, thereby obtaining a slurry. The slurry was applied to the top of the positive-electrode faradic reaction layer 12, thereby forming a positive-electrode non-faradic reaction layer 14. The positive-electrode non-faradic reaction layer 14 was dried and then pressed using a roll press, thereby preparing an electrode. The electrode was then punched in the shape of a disc with a diameter of 16 mm, thereby obtaining a positive-electrode 11. The weight ratio of the positive electrode active material, conductant agent, polyvinylidene fluoride (activated charcoal/positive electrode active material: 19 wt. %), and activated charcoal to the total weight of the positive-electrode faradic reaction layer 12 and the positive-electrode non-faradic reaction layer 14 was 68:10:6:16. Thus, the weight of the activated charcoal was 16 wt. %.

For the negative-electrode active material, amorphous carbon with a mean particle size of 10 μm and carbon black with a specific surface area of 40 m²/g were mechanically mixed to a weight ratio of 95:5. Using a binder formed by dissolving 8 wt. % of polyvinylidene fluoride in N-methylpyrrolidone in advance, a carbon material consisting of the mixture of amorphous carbon and carbon black and polyvinylidene fluoride were sufficiently kneaded to a weight ratio of 90:10, thereby obtaining a slurry. The slurry was applied to one side of a negative-electrode collector 27 made of a copper foil with a thickness of 10 μm which was then dried. The negative-electrode collector 27 was then pressed using a roll press, thereby preparing an electrode. The electrode was punched in the shape of a disc with a diameter of 16 mm, thereby obtaining a negative-electrode 15. Between the positive and negative electrodes, an insulating layer 19 formed of a polyethylene porous separator with a thickness of 40 μm was disposed, and then a 1.5 mol/dm³ LiPF₆ mixture electrolytic solution of ethylene carbonate and ethylmethyl carbonate (volume ratio: 1/9) was injected. A positive-electrode can 1b and a negative-electrode can 1c are sealed with a gasket 1d and are also mutually insulated.

### EXAMPLE 2

An energy device was prepared in the same manner as in Example 1 except that the weight ratio of the positive electrode active material, conductant agent, polyvinylidene fluoride, and activated charcoal to the total weight of the positive-electrode faraday 12 and the positive-electrode non-faradic reaction layer 14 was 74:10:6:10 and the weight of the activated charcoal was 10 wt. %.

### COMPARATIVE EXAMPLE 1

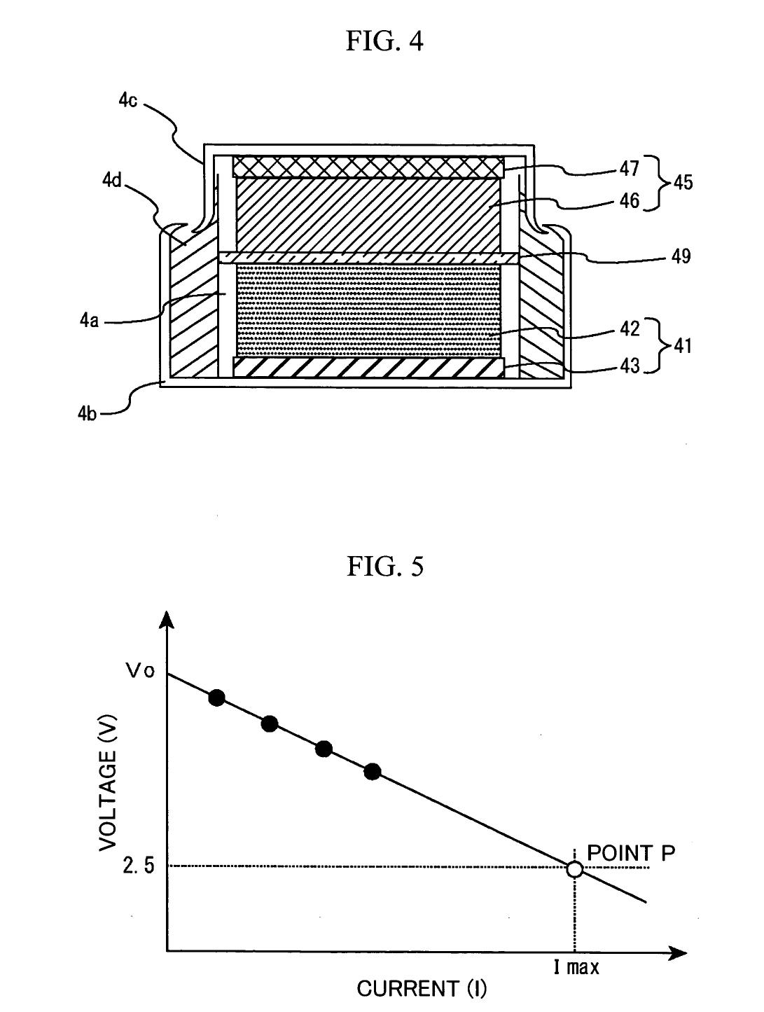

A coin type lithium secondary battery with the configuration of FIG. 4 was made. A positive-electrode 41 was prepared as follows. The positive electrode active material was Li_{1.05}Mn_{1.95}O₄ with a mean particle size of 10 μm. The conductant agent was prepared by mixing graphite carbon with a mean particle size of 3 μm and a specific surface area of 13 m²/g and carbon black with a mean particle size of 0.04 μm and a specific surface area of 40 m²/g to a weight ratio of 4:1. Using a binder prepared by dissolving 8 wt. % of polyvinylidene fluoride in N-methylpyrrolidone in advance, the positive electrode active material, conductant agent, and polyvinylidene fluoride were mixed to a weight ratio of 85:10:5 and then sufficiently kneaded, thereby obtaining a positive-electrode slurry. The positive-electrode slurry was applied to one side of a positive-electrode collector 43 made of an aluminum foil with a thickness of 20 μm which was then dried. The positive-electrode collector 43 was then pressed using a roll press, thereby preparing an electrode. The electrode was punched in the shape of a disc with a diameter of 16 mm, thereby obtaining a positive-electrode 41. A negative-electrode 45 was prepared in the following way.

For the negative-electrode active material, amorphous carbon with a mean particle size of 10 μm and carbon black with a mean particle size of 0.04 μm and a specific surface area of 40 m²/g were mechanically mixed to a weight ratio of 95:5. Using a binder formed by dissolving 8 wt. % of polyvinylidene fluoride in N-methylpyrrolidone in advance, a carbon material consisting of the mixture of amorphous carbon and carbon black and polyvinylidene fluoride were sufficiently kneaded to a weight ratio of 90:10, thereby obtaining a slurry. The slurry was applied to one side of a negative-electrode collector 47 made of a copper foil with a thickness of 10 μm which was then dried. The negative-electrode collector 47 was then pressed using a roll press, thereby preparing an electrode. The electrode was punched in the shape of a disc with a diameter of 16 mm, thereby obtaining a negative-electrode 45. Between the positive and negative electrodes, an insulating layer 49 formed of a polyethylene porous separator with a thickness of 40 μm was disposed, and then a 1.5 mol/dm³ LiPF₆ mixture electrolytic solution of ethylene carbonate and ethylmethyl carbonate (volume ratio: 1/9) was injected. A positive-electrode can 4b and a negative-electrode can 4c are sealed with a gasket 4d and are also mutually insulated.

### COMPARATIVE EXAMPLE 2

An electrode was prepared in the same manner as the positive-electrode 41 of Comparative Example 1 except that the weight ratio of the positive electrode active material, conductant agent, polyvinylidene fluoride, and activated charcoal was 68:10:6:16. Although the positive-electrode contains activated charcoal, this example is not composed of a laminate, such as that of the positive-electrode faradic reaction layer 12 and the positive-electrode non-faradic reaction layer 14 of Example 1. Instead, the activated charcoal is mixed in the positive-electrode 41. Thus, except for the use of such a positive-electrode, a coin type lithium secondary battery was prepared in the same manner as in Comparative Example 1.

However, when this electrode was pressed using a roll press, most of the mixture was peeled off the aluminum foil, thereby failing to obtain a normal electrode.

### COMPARATIVE EXAMPLE 3

An electrode was prepared in the same way as the positive-electrode 41 of Comparative Example 1 except that the weight ratio of the positive electrode active material, conductant agent, polyvinylidene fluoride, and activated charcoal was 74:10:6:10. Although the positive-electrode contains activated charcoal, this example is not composed of a laminate, such as the positive-electrode faradic reaction layer 12 and the positive-electrode non-faradic reaction layer 14 of Example 1. Instead, the activated charcoal is mixed in the positive-electrode 41. Thus, except for the use of such a positive-electrode, a coin type lithium secondary battery was prepared in the same manner as in Comparative Example 1.

The output characteristics of the energy devices of Examples 1 and 2 and that of the lithium secondary battery of Comparative Example 3 were evaluated by the following method.

(Output Characteristics Evaluation Method)

Each of the energy devices and lithium secondary batteries was charged and discharged at 25° C. under the following conditions. Specifically, a constant current/constant voltage charging was conducted for 3 hours, whereby the energy device or lithium secondary battery was charged up to 4.1 V with a constant current with current density of 0.85 mA/cm², followed by constant voltage charging at 4.1 V. After the charging was completed, an interval of 30 min was taken, and then the device or battery was discharged to a discharge end voltage of 2.7 V, with a constant current of 0.28 mA/cm².

Five cycles of the same charge/discharge process were performed, and the discharge capacity at the end of the fifth cycle was determined to be the discharge capacity of each energy device. Thereafter, a constant current/constant voltage charging was conducted for 3 hours whereby the device or battery was charged with a constant current of 85 mA/cm², followed by constant voltage charging at 4.1 V. When the device or battery has been charged to 4.1 V, DOD was considered to be 0%. In this state, the energy device or lithium secondary battery was placed in a constant-temperature bath with temperature of −30° C. After about an hour, discharge was conducted with currents of 0.08 mA/cm², 1.7 mA/cm², and 3.4 mA/cm², for a short period, specifically, 10 seconds, and then the output characteristics were examined.

Ten minutes after each discharge, the energy device or battery was charged with 0.17 mA/cm² for the capacity discharged by each discharge. For example, after discharge with 1.7 mA/cm² for 10 seconds, charge was conducted with 0.17 mA/cm² for 100 seconds. This was followed by an interval of 30 min, and then, when the voltage was stabilized, the next measurement was conducted. Thereafter, discharge was conducted with a constant current of 0.17 mA/cm² to a voltage corresponding to DOD=40%.

Thereafter, the output characteristics were examined under the same condition as when DOD=0% as mentioned above. Specifically, in a charge/discharge curve obtained by the 10-second charge/discharge test, the voltage at 2 seconds after the start of discharge was read and plotted, with the horizontal axis showing the current value at the time of measurement and the vertical axis showing the voltage at 2 seconds after the start of measurement. A line determined from the I-V characteristics shown in FIG. 5 by the least square method was extrapolated so as to determine a point P of intersection with 2.5 V. Output was calculated as the product of the current value Imax at the extrapolated intersection point P and the start voltage Vo of each charge/discharge.

Table 1 shows the result of evaluation of the low-temperature characteristics, showing relative values with respect to the output of the energy device of Example 1 taken as 1. The result shows that in both DOD=0% and 40%, the characteristics of the energy device of Example 1 are superior to those of the lithium secondary battery of Comparative Example 1. Specifically, when DOD=40%, nearly twice as much output was obtained with the energy device of Example 1.

TABLE 1

Output ratio

| Item | DOD = 0% | DOD = 40% |
|---|---|---|
| Example 1 | 1 | 1 |
| Comparative Example 1 | 0.88 | 0.56 |
| Comparative Example 3 | 0.94 | 0.62 |

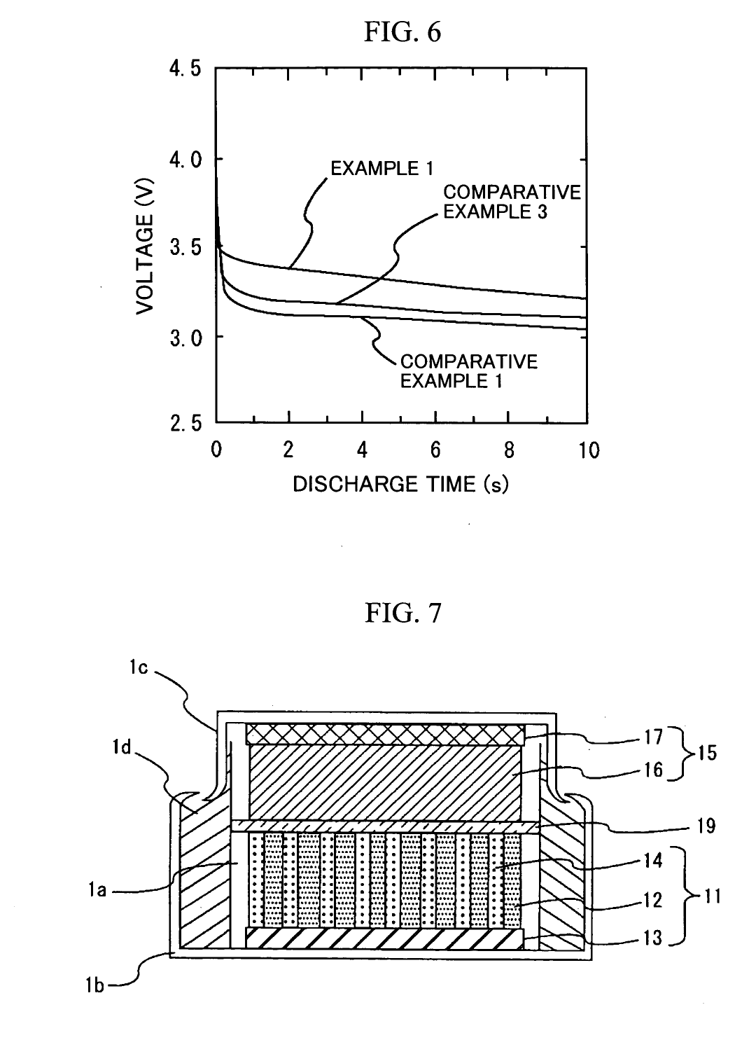

FIG. 6 shows discharge curves plotted when the energy device of Example 1 and the lithium secondary battery of Comparative Example 1 were discharged with 3.4 mA/cm² for 10 seconds at −30° C. with DOD=40%. It can be seen from FIG. 6 that the amount of voltage change from the start of discharge in the energy device of Example 1 is obviously smaller than that of the lithium secondary battery of Comparative Example 1, thus indicating an improvement in output characteristics. Thus, the output characteristics at low temperature can be greatly improved by the energy device of the example.

### EXAMPLE 3

A coin type energy device with a configuration shown in FIG. 7 was made. For a positive-electrode faradic reaction layer 12, the positive-electrode slurry of Comparative Example 1 was applied to one side of a positive-electrode collector 13 consisting of an aluminum foil with a width of 1 mm and a thickness of 20 μm, leaving uncoated regions at 1 mm intervals, and the thus applied layer was then dried. Activated charcoal with a specific surface area of 2000 m²/g and carbon black with a mean particle size of 0.04 μm and a specific surface area of 40 m²/g were mixed to a weight ratio of 8:1. Using a binder consisting of a solution prepared by dissolving 8 wt. % of polyvinylidene fluoride in N-methylpyrrolidone in advance, the activated charcoal, carbon black, and polyvinylidene fluoride were mixed to a weight ratio of 80:10:10 and sufficiently kneaded, thereby preparing a slurry. The slurry was applied to the uncoated regions on the positive-electrode collector 13, thereby forming a positive-electrode non-faradic reaction layer 14. The positive-electrode non-faradic reaction layer 14 was then dried and pressed using a roll press, thereby preparing an electrode, which was further punched in the shape of a disc with a diameter of 16 mm into a positive-electrode 11. The weight ratio of the positive electrode active material, conductant agent, polyvinylidene fluoride, and activated charcoal to the total weight of the positive-electrode faradic reaction layer 12 and the positive-electrode non-faradic reaction layer 14 was 68:10:6:16, and the weight of the activated charcoal was 16 wt. %. A negative-electrode 15 was prepared in the same manner as the negative-electrode 45 of Comparative Example 1, namely, by coating on a negative-electrode collector 17 and then pressing it into an electrode which was then punched in the shape of a disc with a diameter of 16 mm. An insulating layer 19 consisting of a polyethylene porous separator with a thickness of 40 μm was disposed between the positive and negative electrodes, and then a 1.5 mol/dm³ LiPF₆ mixture electrolytic solution 1a of ethylene carbonate and ethylmethyl carbonate (volume ratio: 1/9) was injected. A positive-electrode can 1b and a negative-electrode can 1c are sealed with a gasket 1d and insulated from one another.

### EXAMPLE 4

A coin type energy device with a configuration shown in FIG. 7 was made. For a positive-electrode faradic reaction layer 12, the positive-electrode slurry of Comparative Example 1 and Example 3 was applied to one side of a positive-electrode collector 13 consisting of an aluminum foil with a width of 2 mm and a thickness of 20 μm, leaving uncoated regions at 1 mm intervals, and the thus applied layer was then dried. Activated charcoal with a specific surface area of 2000 m²/g and carbon black with a mean particle size of 0.04 μm and a specific surface area of 40 m²/g were mixed to a weight ratio of 8:1, as in Example 3. Using a binder consisting of a solution prepared by dissolving 8 wt. % of polyvinylidene fluoride in N-methylpyrrolidone in advance, the activated charcoal, carbon black, and polyvinylidene fluoride were mixed to a weight ratio of 80:10:10 and sufficiently kneaded, thereby preparing a slurry. The slurry was applied to the uncoated regions on the positive-electrode collector 13, thereby forming a positive-electrode non-faradic reaction layer 14. The positive-electrode non-faradic reaction layer 14 was then dried and pressed using a roll press, thereby preparing an electrode, which was further punched in the shape of a disc with a diameter of 16 mm into a positive-electrode 11. The weight ratio of the positive electrode active material, conductant agent, polyvinylidene fluoride, and activated charcoal to the total weight of the positive-electrode faradic reaction layer 12 and the positive-electrode non-faradic reaction layer 14 was 68:10:6:16, and the weight of the activated charcoal was 16 wt. %. A negative-electrode 15 was prepared in the same manner as the negative-electrode 45 of Comparative Example 1, namely, by coating on a negative-electrode collector 17 and then pressing it into an electrode which was then punched in the shape of a disc with a diameter of 16 mm. An insulating layer 19 consisting of a polyethylene porous separator with a thickness of 40 μm was disposed between the positive and negative electrodes, and then a 1.5 mol/dm³ LiPF₆ mixture electrolytic solution 1a of ethylene carbonate and ethylmethyl carbonate (volume ratio: 1/9) was injected. A positive-electrode can 1b and a negative-electrode can 1c are sealed with a gasket 1d and insulated from one another.

The output characteristics of the energy devices of Examples 3 and 4 and the lithium secondary battery of Comparative Example 1 at low temperature were evaluated by the above-described method.

TABLE 2

Output ratio

| Item | DOD = 0% | DOD = 40% |
|---|---|---|
| Example 3 | 1 | 1 |
| Example 4 | 0.97 | 0.93 |
| Comparative Example 1 | 0.88 | 0.56 |

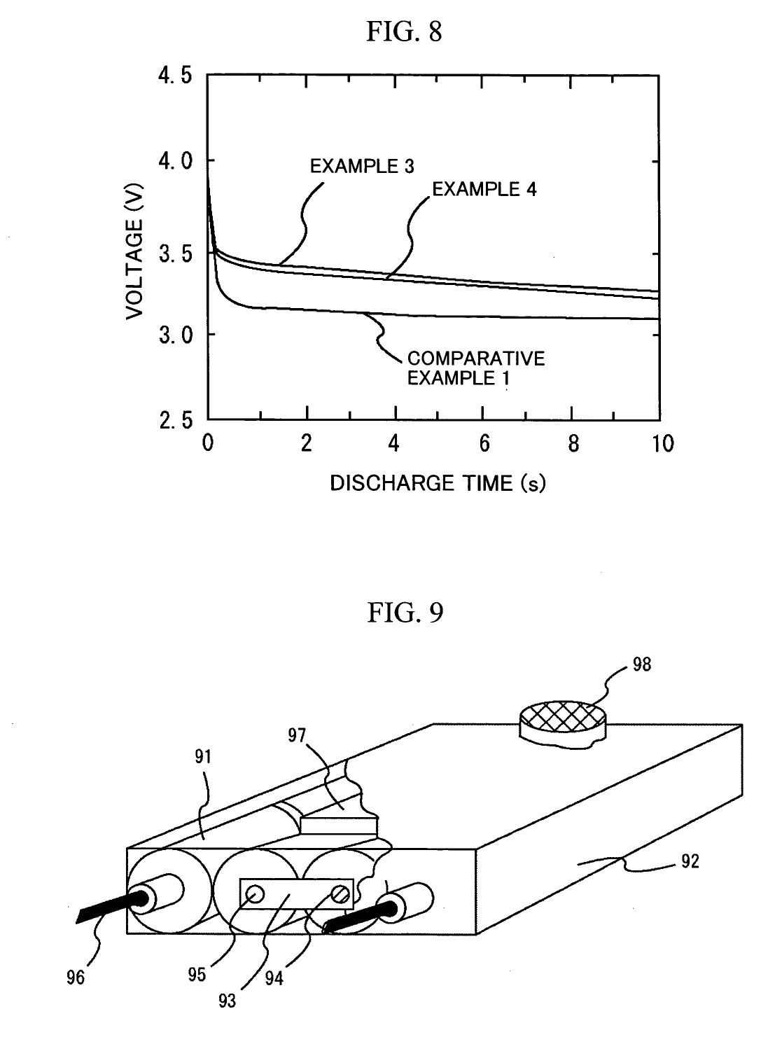

The results shown in Table 1 are relative values with respect to the output of the energy device of Example 3 taken as one. As shown, the characteristics of the energy device of Example 3 are superior to those of the lithium secondary battery of Comparative Example 1 in both cases of DOD=0% and 40%. In the case of DOD=40%, about twice as much output were obtained with the energy device of Example 3. FIG. 8 shows discharge curves plotted when the energy devices of Examples 3 and 4 and the lithium secondary battery of Comparative Example 1 were discharged with 3.4 mA/cm² for 10 seconds at −30° C. when DOD=40%. It can be seen that the amount of voltage change from the start of discharge in the energy devices of Examples 3 and 4 is clearly smaller than that of the lithium secondary battery of Comparative Example 1, thereby indicating improvements on the output characteristics. Thus, the output characteristics at low temperature can be greatly improved by using the energy device of the invention.

Mainly based on FIG. 7, it is possible to form the layer in which fast faradaic reaction or non-faradaic reaction takes place only for the positive-electrode 11. It is also possible to prepare an energy device by forming the layer in which fast faradaic reaction or non-faradaic reaction takes place only for the negative-electrode.

The insulating layer 19 of FIG. 7 may alternatively be formed of a gel electrolyte.

### EXAMPLE 5

A coin type energy device was prepared in the same way as Example 1 except that, instead of the electrolytic solution of Example 1, a 1.5 mol/dm³ LiPF₆ mixture electrolytic solution of 1,1,2,2,3,3,4-heptafluorocyclopentane and propylene carbonate (volume ratio: 1/9) was used.

### EXAMPLE 6

A coin type energy device was prepared in the same way as Example 1 except that the negative-electrode active material was graphite carbon with a mean particle size of 15 μm and, instead of the electrolytic solution of Example 1, a 1.5 mol/dm³ LiPF₆ mixture electrolytic solution of 1,1,2,2,3,3,4-heptafluorocyclopentane and propylene carbonate (volume ratio: 1/9) was used.

### EXAMPLE 7

A coin type energy device was prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and γ-butyrolactone (volume ratio: 1/9) was used.

### EXAMPLE 8

A coin type energy device was prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and α-acetyl-γ-butyrolactone (volume ratio: 1/9) was used.

### EXAMPLE 9

A coin type energy device was prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and α-methoxy-γ-butyrolactone (volume ratio: 1/9) was used.

### COMPARATIVE EXAMPLE 4

A coin type energy device was prepared in the same way as Example 6 except that, instead of the electrolytic solution of Example 6, a 1 mol/dm³ LiPF₆ mixture electrolytic solution of ethylene carbonate and diethyl carbonate (volume ratio: 1/1) was used.

### COMPARATIVE EXAMPLE 5

A coin type energy device was prepared in the same way as Example 6 except that, instead of the electrolytic solution of Example 6, a 1 mol/dm³ LiPF₆ propylene carbonate electrolytic solution was used.

The discharge capacity and the output characteristics at −30° C. of Example 1 and Examples 5 to 9 and Comparative Examples 4 and 5 were evaluated by the above-described method (Output characteristics evaluation method).

Table 3 shows the discharge capacities and output densities at −30° C. as relative values with respect to the value of Example 1 taken as 100. In Comparative Example 4, the discharge capacity increased when graphite carbon was used in the negative-electrode, but the output density greatly decreased at −30° C. When graphite carbon was used in the negative-electrode and propylene carbonate was used in the electrolytic solution, as in Comparative Example 5, the energy device could not be discharged. In contrast, the energy devices of Examples 5 to 9 all showed improvements in terms of discharge capacity and output density, although Example 5 showed slightly reduced discharge capacity.

Thus, the output characteristics at low temperature can be greatly improved by using the energy device of the invention.

TABLE 3

| | Discharge capacity | Discharge density |
|---|---|---|
| | ratio (%) | ratio (%) |
| Example 1 | 131 | 133 |
| Example 2 | 128 | 129 |
| Example 3 | 125 | 119 |
| Example 4 | 122 | 118 |
| Comparative Example 1 | 100 | 100 |
| Comparative Example 2 | 134 | 53 |

| | |
|---|---|
| Comparative Example 3 | Cannot discharge |

### EXAMPLE 10

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and butylene carbonate (volume ratio: 1/9) is used.

### EXAMPLE 11

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and dimethyl carbonate (volume ratio: 1/9) is used.

### EXAMPLE 12

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and ethyl methyl carbonate (volume ratio: 1/9) is used.

### EXAMPLE 13

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and diethyl carbonate (volume ratio: 1/9) is used.

### EXAMPLE 14

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and methyl acetate (volume ratio: 1/9) is used.

### EXAMPLE 15

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and ethyl acetate (volume ratio: 1/9) is used.

### EXAMPLE 16

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and propyl acetate (volume ratio: 1/9) is used.

### EXAMPLE 17

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and methyl formate (volume ratio: 1/9) is used.

### EXAMPLE 18

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and ethyl formate (volume ratio: 1/9) is used.

### EXAMPLE 19

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and propyl formate (volume ratio: 1/9) is used.

### EXAMPLE 20

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and dioxolan (volume ratio: 1/9) is used.

### EXAMPLE 21

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and sulfolane (volume ratio: 1/9) is used.

### EXAMPLE 22

A coin type energy device is prepared in the same way as Example 6 except that, instead of the electrolytic solution of Example 6, a 1.5 mol/dm³ LiPF₆ mixture electrolytic solution of 1,1,2,2,3,3,4-heptafluorocyclopentane and ethylene sulfite (volume ratio: 1/9) is used.

### EXAMPLE 23

A coin type energy device is prepared in the same way as Example 6 except that, instead of the electrolytic solution of Example 6, a 1.5 mol/dm³ LiBF₄ mixture electrolytic solution of 1,1,2,2,3,3,4-heptafluorocyclopentane and propylene carbonate (volume ratio: 1/9) is used.

### EXAMPLE 24

A coin type energy device is prepared in the same way as Example 6 except that, instead of the electrolytic solution of Example 6, a 1.5 mol/dm³ LiSO₂CF₃ mixture electrolytic solution of 1,1,2,2,3,3,4-heptafluorocyclopentane and propylene carbonate (volume ratio: 1/9) is used.

### EXAMPLE 25

A coin type energy device is prepared in the same way as Example 6 except that, instead of the electrolytic solution of Example 6, a 1.5 mol/dm³ LiN [SO₂CF₃]₂ mixture electrolytic solution of 1,1,2,2,3,3,4-heptafluorocyclopentane and propylene carbonate (volume ratio: 1/9) is used.

### EXAMPLE 26

A coin type energy device is prepared in the same way as Example 6 except that, instead of the electrolytic solution of Example 6, a 1.5 mol/dm³ LiN [SO₂CF₂CF₃]₂ mixture electrolytic solution of 1,1,2,2,3,3,4-heptafluorocyclopentane and propylene carbonate (volume ratio: 1/9) is used.

### EXAMPLE 27

A coin type energy device is prepared in the same way as Example 6 except that, instead of the electrolytic solution of Example 6, a 1.5 mol/dm³ LiB [OCOCF₃]₄ mixture electrolytic solution of 1,1,2,2,3,3,4-heptafluorocyclopentane and propylene carbonate (volume ratio: 1/9) is used.

### EXAMPLE 28

A coin type energy device is prepared in the same way as Example 6 except that, instead of the electrolytic solution of Example 6, a 1.5 mol/dm³ LiB [OCOCF₂CF₃]₄ mixture electrolytic solution of 1,1,2,2,3,3,4-heptafluorocyclopentane and propylene carbonate (volume ratio: 1/9) is used.

### EXAMPLE 29

A coin type energy device is prepared in the same way as Example 6 except that, instead of the electrolytic solution of Example 6, a 1.5 mol/dm³ LiPF₆ and 0.05 mol/dm³ (C₂H₅)₄NBF₄ mixture electrolytic solution of 1,1,2,2,3,3,4-heptafluorocyclopentane and propylene carbonate (volume ratio: 1/9) is used.

### EXAMPLE 30

A coin type energy device is prepared using LiNi_{0.8}Co_{0.15}Al_{0.05}O₂ with a mean particle size of 6 μm as the positive electrode active material in the positive electrode active material layer. Initially, a positive electrode active material layer is prepared. The conductant agent consists of a mixture of graphite carbon with a mean particle size of 3 μm and a specific surface area of 13 m²/g and carbon black with a mean particle size of 0.04 μm and a specific surface area of 40 m²/g to a weight ratio of 4:1. Using a binder prepared by dissolving 8 wt. % of polyvinylidene fluoride in N-methylpyrroridone in advance, the positive electrode active material, conductant agent, and polyvinylidene fluoride are mixed to a weight ratio of 85:10:5 and sufficiently kneaded, thereby preparing a positive-electrode slurry. The positive-electrode slurry is then applied to one side of a positive-electrode collector consisting of an aluminum foil with a thickness of 20 μm, dried, and then pressed with a roll press. Thereafter, an activated charcoal layer is provided on the positive-electrode active material layer as follows. Activated charcoal with a specific surface area of 2000 m²/g, carbon black with a mean particle size of 0.04 μm and a specific surface area of 40 m²/g were mixed to a weight ratio of 8:1. Using a binder prepared by dissolving 8 wt. % of polyvinylidene fluoride in N-methylpyrrolidone in advance, the activated charcoal, carbon black, and polyvinylidene fluoride are mixed to a weight ratio of 80:10:10 and then sufficiently kneaded, thereby obtaining a slurry, which is then applied to the top of the positive electrode active material layer. The thus coated layer is dried and then pressed with a roll press, thereby preparing an electrode. The electrode is then punched in the shape of a disc with a diameter of 16 mm, thereby obtaining a positive-electrode. A coin type energy device is then prepared in the same manner as Example 5 except for the use of the thus prepared positive-electrode.

### EXAMPLE 31

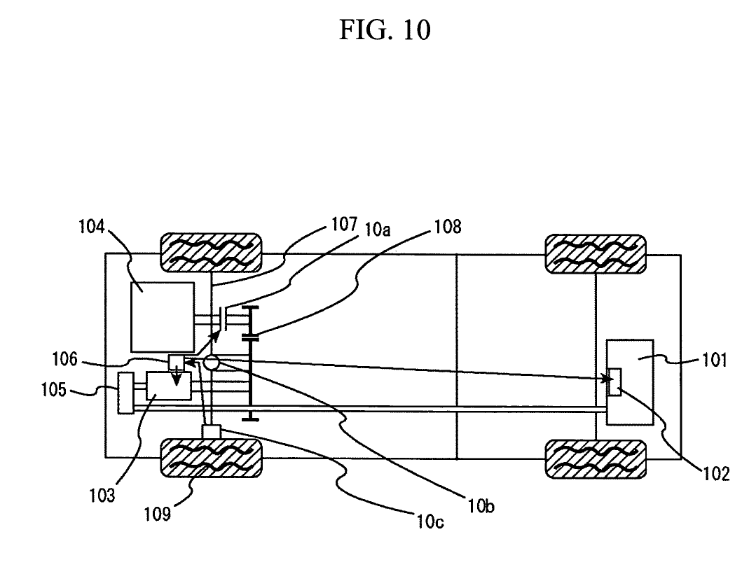

Using a plurality of the energy storage devices prepared in Example 1, an energy storage device module shown in FIG. 9 was prepared. Twenty-four energy storage devices 91 were connected in series and housed in a rectangular resin container 92. For the connection between the individual energy storage devices 91, a copper plate 93 with a thickness of 2 mm was used. The copper plate 93 was securely fastened with screws so as to connect a positive-electrode terminal 94 and a negative-electrode terminal 95 of the energy storage devices 91. Charge/discharge current for the module is supplied via a cable 96. Each of the energy storage devices 91 is connected to a control circuit 97 via signal lines, so that the voltage and temperature of each energy storage device 91 can be monitored during charge or discharge. The module is fitted with a ventilation opening 98 for cooling purposes.

### EXAMPLE 32

Using two of the energy storage device modules prepared in Example 31, a hybrid electric vehicle was fabricated. Referring to FIG. 10, numeral 101 designates an energy storage device module; 102 a module control circuit; 103 a driving electric motor; 104 engine; 105 an inverter; 106 a power control circuit; 107 a driving axle; 108 a differential gear; 109 a driving wheel; 10a a clutch; 10b gears; and 10c a vehicle speed monitor. When the vehicle starts, the electric power from the energy storage device module 101 is converted into alternating current in the inverter 105. The AC-converted power is then fed to the driving electric motor 103 for rotating the driving wheel 109, whereby the vehicle can be moved. In accordance with a signal fed from the power control circuit 106, the module control circuit 102 causes the energy storage device module 101 to feed electric power to the driving electric motor 103. If the vehicle speed exceeds 20 km/h when the vehicle is driven by the driving electric motor 103, the power control circuit 106 sends a signal to cause the clutch 10a to be engaged such that the rotational energy from the driving wheel 109 can be used for cranking the engine 104. The signal from the vehicle speed monitor 10c and information about the degree of application of the accelerator pedal are processed by the power control circuit 106, which then controls the feeding of electric power to the driving electric motor 103 so as to control the rpm of the engine 104. During deceleration, the driving electric motor 103 operates as a generator for regenerating electric power to the energy storage device module 101. By installing the energy storage device module of the invention, which is lightweight, better mileage can be obtained.

Although the above-described example involved an internal combustion-engine hybrid electric vehicle, this is merely an example and it is also possible to adopt a hybrid with a fuel cell. In this case, components for internal combustion, such as engine, can be eliminated. Further alternatively, it is also possible to produce a purely electric vehicle installed solely with the energy storage device module.

### INDUSTRIAL FIELD OF APPLICATION

The applications of the energy device or energy device module according to the invention are not limited in any particular way. For example, they can be applied as the power supply for portable information/communications devices, such as personal computers, word processors, cordless handsets, electronic book players, cellular phones, automobile phones, pagers, handy terminals, transceivers, and portable radio equipment. Other application include the power supply for portable copy machines, electronic organizers, calculators, LCD television sets, radios, tape recorders, headphone stereos, portable CD players, video movie recorders, electric shavers, electronic translating machines, voice input machines, and memory cards. Other examples of application include household appliances, such as refrigerators, air conditioners, television sets, stereo equipment, water heaters, microwave ovens, dishwashers, driers, washing machines, lighting equipment, and toys. For industrial purposes, the invention can be applied to medical equipment, electric power storage systems, and elevators, for example. The invention can be applied particularly effectively in equipment or systems that require high input and output levels, such as the power supplies for moving objects including electric vehicles, hybrid electric vehicles, and golf carts, for example.

What is claimed is:

1. An energy device comprising a positive-electrode and a negative-electrode for storing electricity by means of a faradaic reaction and a non-faradaic reaction, and an electrolytic solution containing a solvent in which mobile ion is stored, which solvent is represented by the following formula (Formula 1): 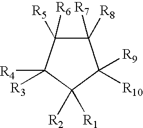
where R₁ to R₁₀ are hydrogen, fluorine, or a methyl or methoxy group, which may all be the same or different from one another.

2. The energy device according to claim 1, wherein the solvent represented by Formula 1 is 1, 1,2,2,3,3,4-heptafluorocyclopentane.

3. The energy device according to claim 1, comprising the solvent represented by Formula 1 and at least one solvent selected from the group consisting of propylene carbonate, butylene carbonate, dimethyl carbonate, ethyl methyl carbonate, diethyl carbonate, methyl acetate, ethyl acetate, propyl acetate, methyl formate, ethyl formate, propyl formate, γ-butyrolactone, α-acetyl-γ-butyrolactone, α-methoxy-γ-butyrolactone, dioxolan, sulfolane, or ethylene sulfite.

4. The energy device according to claim 1, wherein the negative-electrode of the device contains graphite carbon as a substance for storing electricity by a faradaic reaction.

5. The energy device according to claim 1, wherein the positive-electrode contains, as a substance for storing electricity by a faradaic reaction, a compound oxide represented by LiNiₓMn_{y}Co_{z}O₂ (x+y+z=1) or Li and one or a plurality of kinds of transition metals, such as Co, Ni, and/or Mn, or a compound with the olivine structure represented by LiMePO₄ (where Me is Fe, Co, or Cr).

6. The energy device according to claim 1, wherein activated charcoal carbon material is used as a material for storing electricity by a non-faradaic reaction.

7. The energy device according to claim 1, wherein the electrolytic solution contains at least one type of lithium salt selected from the group consisting of LiPF₆, LiBF₄, LiSO₂CF₃, LiN [SO₂CF₃]₂, LiN [SO₂CF₂CF₃]₂, LiB [OCOCF₃]₄, or LiB [OCOCF₂CF₃]₄.

8. The energy device according to claim 7, comprising a quaternary onium cation salt represented by the following chemical formula (Chemical Formula 1): 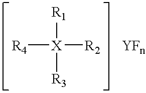
where R₁, R₂, R₃, and R₄ are H or alkyl groups with carbon number of 1 to 3, which may all be the same or different from one another; X is N or P; Y is B, P, or As; and n is an integer of 4 or 6.

9. The energy device according to claim 1, wherein a gel electrolyte comprising a polymer and an electrolytic solution is disposed between the positive and negative electrodes.

10. An energy device module comprising a plurality of the energy devices according to claim 1 that are connected in parallel or in series, and a control circuit for controlling the plurality of energy devices.

11. An electric vehicle on which the module according to claim 10 is installed, the electric vehicle further comprising an electric motor driven by electric power supplied from the module, or such an electric motor and an internal combustion engine.
